(19) United States
(12) Patent Application Publication
(10) Pub. No.: US 2023/0337855 A1
(43) Pub. Date: Oct. 26, 2023

(54) CONVECTION OVEN

(71) Applicant: ILLINOIS TOOL WORKS INC., Glenview, IL (US)

(72) Inventors: Randall B. DIGGINS, Baltimore, MD (US); Nicholas C. STONE, Bel Air, MD (US); Kacy W. DENNING, Charlotte, NC (US); Henry SAWTELLE, Portland, OR (US); Peter Welsh SCHELLENBACH, JR., Baltimore, MD (US); Darrin FURGASON, Aberdeen, MD (US)

(21) Appl. No.: 18/303,130

(22) Filed: Apr. 19, 2023

Related U.S. Application Data
(63) Continuation-in-part of application No. 17/202,505, filed on Mar. 16, 2021.
(60) Provisional application No. 62/991,640, filed on Mar. 19, 2020.

(51) Int. Cl. F24C 7/08; F24C 15/02; A47J 37/06

(52) U.S. Cl. CPC A47J 37/0641; F24C 7/086; F24C 15/02; A47J 2202/00

(57) ABSTRACT

A convection cooking oven includes a cooking cavity for receiving food product to be cooked, a door movable between an open condition and a closed condition relative to the cooking cavity and a heater for generating heat. A fan system is provided for moving heated air within the cooking cavity. A controller is configured to operate the oven in an energy save mode and a normal mode, and to automatically switch between the two modes.

### TECHNICAL FIELD

This application relates generally to commercial cooking ovens and, more specifically, to convection ovens.

### BACKGROUND

In commercial kitchens (e.g., found in restaurant, cafeteria and retail environments), convection ovens are used for cooking a large variety of food items. Such ovens may utilize heaters in the form of either gas-burners or electric elements (e.g., resistive heaters) for generating heat, in combination with one or more fans to move heated air within the oven. Commercial kitchens are high volume cooking environments in which the door of the oven is repeatedly being opened and closed, which can result in large energy losses. Leakage past the oven door seals and through a steam vent in the oven also occur, even when the oven door is closed and the oven is simply idling (e.g., in a ready state waiting for an operator to place an item to be cooked into the oven).

Typical convection ovens may have a high fan speed and a low fan speed, where the fan speed is manually controlled by an operator using a switch or other input on the oven interface. The higher the fan speed, the higher the volumetric flow rate of air and, thus, the higher the energy losses (e.g., due to higher leakage around door seals etc.). Operators commonly run the fan at high speed because the high speed tends to produce a more even bake. As a result, for efficiency rating purposes, the ovens are also tested with the fan at high speed, which adversely impacts efficiency.

Accordingly, it would be desirable to provide a convection oven configured to control fan speed in a more effective manner that increases oven efficiency.

### SUMMARY

In one aspect, a convection cooking oven includes a cooking cavity for receiving food product to be cooked, a door movable between an open condition and a closed condition relative to the cooking cavity, a heater for heating air, a fan system for moving heated air within the cooking cavity, and a user interface including an on/off switch, a temperature control input for defining a cook temperature setpoint and a fan control input, wherein the fan control input is a fan switch manually variable between a first position corresponding to a fan system high speed and a second position corresponding to a fan system low speed. A controller is provided for selectively overriding the fan system high speed, the controller configured such that, with the fan switch in the first position: when the convection cooking oven is initially turned on via the on/off switch, the convection cooking oven is initially operated in an energy save mode that includes operation of the fan system at the fan system low speed and the convection cooking oven is automatically switched to operation in a normal mode that includes operation of the fan system at the fan system high speed if at least one of a plurality of mode change trigger conditions is detected, the plurality of mode change trigger conditions including: (i) opening of the door; (ii) adjustment of the cook temperature setpoint via the temperature control input.

In another aspect, a convection cooking oven includes a cooking cavity for receiving food product to be cooked, a door movable between an open condition and a closed condition relative to the cooking cavity, a heater for heating air, a fan system for moving heated air within the cooking cavity, and a user interface including a temperature control input for defining a cook temperature setpoint and a fan control input for selecting a fan system high speed and at least one fan system low speed. A controller is provided for selectively overriding the fan system high speed, the controller configured such that, when the fan control input has been used to select the fan system high speed: when the convection cooking oven is initially turned on, the convection cooking oven is initially operated in an energy save mode that includes operation of the fan system at a fan system speed that is lower than the fan system high speed.

In a further aspect, a method is provided for operating a convection cooking oven that includes a cooking cavity for receiving food product to be cooked, a door movable between an open condition and a closed condition relative to the cooking cavity, a heater for heating air and a fan system for moving heated air within the cooking cavity, the method including: upon initial oven start-up, automatically: operating the fan system at a fan system speed that is lower than an actual fan speed setting, and controlling a cooking temperature within the cooking cavity to a temperature that is lower than an actual cook temperature setting; and after at least one trigger condition occurs, automatically: changing the fan system speed to a speed corresponding to the actual fan speed setting, and controlling the cooking temperature within the cooking cavity to a temperature that corresponds to the actual cook temperature setting.

In another aspect, a cooking oven includes a fan speed control that reduces energy losses by automatically switching a fan system to produce a lesser flow rate under one or more predefined oven conditions.

In another aspect, a convection cooking oven includes a cooking cavity for receiving food product to be cooked and a door movable between an open condition and a closed condition relative to the cooking cavity. The oven includes a heater for heating air, and a fan system for moving heated air within the cooking cavity, where the fan system is operable in a first mode for moving air at a first rate or in a second mode for moving air at a second rate, wherein the first rate is higher than the second rate. A user interface includes a control input for manually selecting one of the first mode or the second mode for operation of the fan system. A fan system override control is configured such that, when the first mode is manually selected, the fan system is automatically switched to operate in the second mode based upon occurrence of a first predefined oven condition.

In still another aspect, a convection cooking oven includes a cooking cavity for receiving food product to be cooked, a door movable between an open condition and a closed condition relative to the cooking cavity and a heater for generating heat. A fan system is provided for moving heated air within the cooking cavity, the fan system operable in both a first mode in which air is moved at a first rate, and a second mode in which either (i) air is moved at a second rate, which is lower than the first rate, or (ii) air is not moved by the fan system. A fan system override control is configured such that, when the fan system is operating in the first mode, the fan system is automatically switched to operate in the second mode based upon occurrence of a first predefined oven condition.

In yet another aspect, a convection cooking oven includes a cooking cavity for receiving food product to be cooked, and a heating system including a heater and a fan for moving heated air within the cooking cavity, the fan operable in a first mode for moving air at a first rate or in a second mode for moving air at a second rate, wherein the first rate is higher than the second rate. A user interface includes a control input for selecting one of the first mode or the second mode for operation of the fan system. A fan override is control configured such that, when the first mode is selected, the fan automatically switches to operate in the second mode based upon occurrence of a predefined oven condition.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of a convection oven;

FIG. 2 is a schematic view of the oven interface;

FIG. 3 is a schematic view of the oven;

FIG. 4 is an exemplary flow chart of oven operation; and

FIG. 5 is another exemplary flow chart of oven operation.

### DETAILED DESCRIPTION

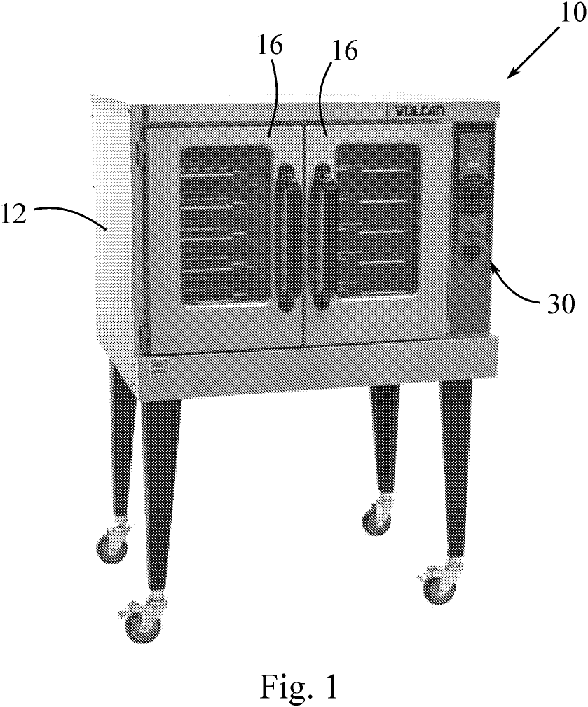

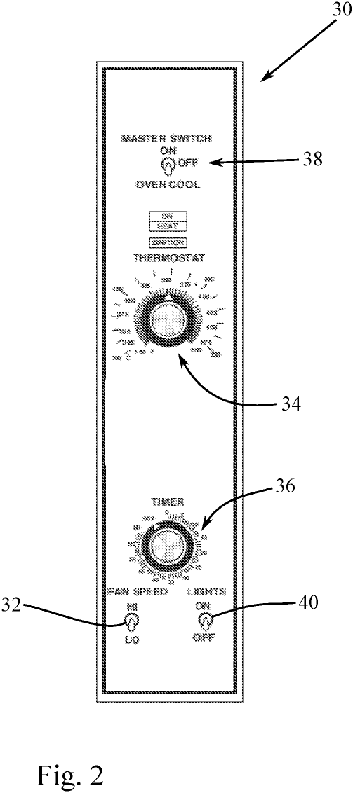

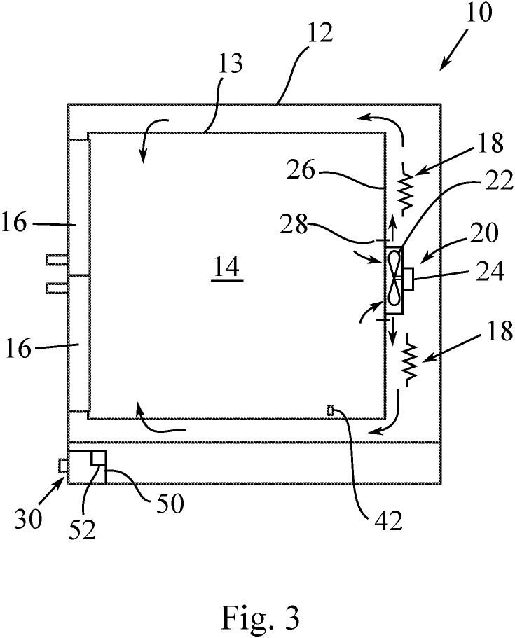

Referring to FIGS. 1-4, a convection cooking oven 10 includes an external housing 12 and an internal housing 13 defining a cooking cavity 14 for receiving food product to be cooked. One or more doors 16 are movable between an open condition and a closed condition relative to the cooking cavity. One or more heaters 18 is provided for generating heat. Here, resistive heating elements are shown, but other heater types (e.g., gas) could be utilized.

A fan system 20 is provided for moving heated air within the cooking cavity 14 to more effectively and evenly heat loaded food product. Here, the fan system 20 is formed by a single fan 22 and fan motor 24 located along a back wall 26 of the cavity 14, in alignment with an opening 28 of the back wall. However, in other embodiments, multiple fans could be used. The fan system is operable at a fan high speed for moving air at a high rate or in a fan low peed for moving air at a low rate. In the illustrated embodiment, operation of the fan 22 pulls air from the oven cavity, moves the air past the heaters and alongside the exterior of the cavity walls, and then back into the cavity in a circulating manner. However, other variations of convection air flow are possible and within the scope of this application.

A user interface 30 includes a control input 32 (here a fan switch) for manually selecting the fan high speed or the fan low speed. The illustrated interface 30 also includes a temperature control knob 34 for use in setting a cook temperature, a timer control knob 36 for use in setting a cooking duration, a master ON/OFF switch 38 and a light control switch 40. In other embodiments, the user interface could be more advance, such as employing a touch-screen interface (e.g., with the control input for the fan speed being selectable on the display, with the cook temperature setting being selectable on the display, with the cooking duration being selectable on the display, etc.).

A controller 50 is responsive to the user interface inputs. The controller 50 may take on various forms, incorporating electrical and electronic circuitry and/or other components. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group - including hardware or software that executes code), software, firmware and/or other components, or a combination of some or all of the above, that carries out the control functions of the machine or the control functions of any component thereof.

Regardless of the exact configuration of the controller 50, the controller is configured with a fan system override control 52 that, in turn, is configured such that, when the first mode for the fan system is manually selected by use of the switch 32, the fan system will automatically be switched to operate in the second mode based upon occurrence of a predefined oven condition. More specifically, the predefined oven condition is selected such that the fan system operates in the first mode primarily when the higher convection air flow rate is most needed, and switches to the second mode when a lower convection flow rate will not adversely impact the cooking operation.

By way of example, the predefined operating condition may be a call for heat condition of the oven (e.g., based upon whether the heater(s) are turned ON or OFF). In this example, when the first mode is selective or otherwise active, the first mode will be maintained while the oven is heating up (heaters on) and the second mode will be automatically triggered when the oven reaches the designated temperature set point for the cooking operation (at which point the heaters turn off). The fan system override control 52 may include a relay, the state of which is controlled by current flow, or lack thereof, through the heaters 16, to achieve the override result. Thus, the fan system override control also automatically switches the fan system back to the first mode when appropriate (e.g., when current flow the heater(s) resumes)).

Thus, the override operation allows the oven to operate with reduced energy losses when the higher convection flow rate is not actually needed for the cooking operation. The override reduces current draw during part of the cooking cycle and during a majority of the time the oven is in an idle state (running with no food in the cavity). The override also reduces the amount of air leakage due to the lower convection flow rate. Further, the switching between the convection flow rates beaks up standing waves of air flow in the oven, which improves overall baking consistency.

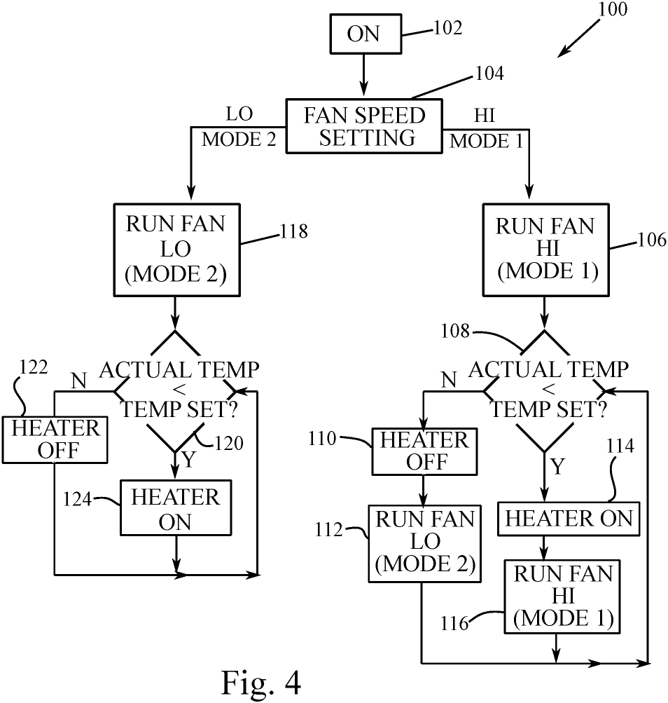

Various predefined oven conditions could be implemented for the purpose of the fan system override control. The predefined oven condition may be a temperature condition of the cooking cavity (e.g., indicated by temperature sensor/thermostat 42). For example, the temperature condition may be a temperature of the cooking cavity reaching either a temperature set point for cooking or a predefined temperature that is below the temperature set point for cooking. The flow chart 100 FIG. 4 depicts oven operation when the fan speed setting is either set to HI or LO. By way of example, the ON condition 102 may be controlled by master switch, and the fan speed setting condition 104 may be controlled by the switch 32. As depicted in the right side of the flow chart, when the fan is set to the HI mode, the fan runs at HI per 106, but can automatically switch to the LO mode, per 112, when the sensed temperature reaches the temperature set point, per 108, and the heater turns off per 110. In this case, the override of the fan speed setting triggers off of the call for heat according to whether the actual oven temperature is at the set point. More generally, however, as used herein, a “call for heat condition” of the oven encompasses oven conditions in which the oven controller is configured to activate the heater(s), regardless of how the call for heat condition is determined to exist (e.g., direct sensing of temperature or sensing of current flow to the heater(s)). Once the temperature falls back below the set point, the heater is turned back on, per 114, and the fan is switched back to the HI mode, per 116. Notably, in this example, when the fan is set to the LO mode by the switch per 104, the LO mode is maintained and there is no override that switches the fan back to the HI mode, per 118, 120, 122 and 124.

As another example, the temperature condition may be a temperature of the cooking cavity remaining within a predefined range of a temperature set point for at least a set time period (e.g., actual temperature no less than ten degrees below the set point for five minutes or ten minutes). As another example, the temperature condition may be a temperature change condition (e.g., falling temperature triggers second mode, rising temperature returns to first mode). As another example, the temperature condition may be a rate of temperature change condition (e.g., as long as the rate of change is below a set threshold, the second mode is triggered). Other variations are also possible.

The first mode may result in a first effective (average) fan motor operating speed and the second mode may result in a second effective fan motor operating speed, where the first effective fan motor operating speed is faster than the second effective fan motor operating speed. Although a simple change in actual fan speed is primarily contemplated above as corresponding to the effective fan speeds, other variations are possible. For example, the effective speeds may be achieved by pulsed operation of the fan motor according to respective duty cycles for the first mode and the second mode.

In another variation, the fan system may include multiple fans, and in the first mode two or more fans run, and in the second mode at least one of the two or more fans does not run.

It is to be clearly understood that the above description is intended by way of illustration and example only, is not intended to be taken by way of limitation, and that other changes and modifications are possible. For example, ovens which do not include a manual fan speed control input could also employ a fan system override control as contemplated above, with the fan system operating in the first mode at all times when the predefined oven condition is not detected or present. As another example, in the second mode, the convection air flow may be stopped entirely.

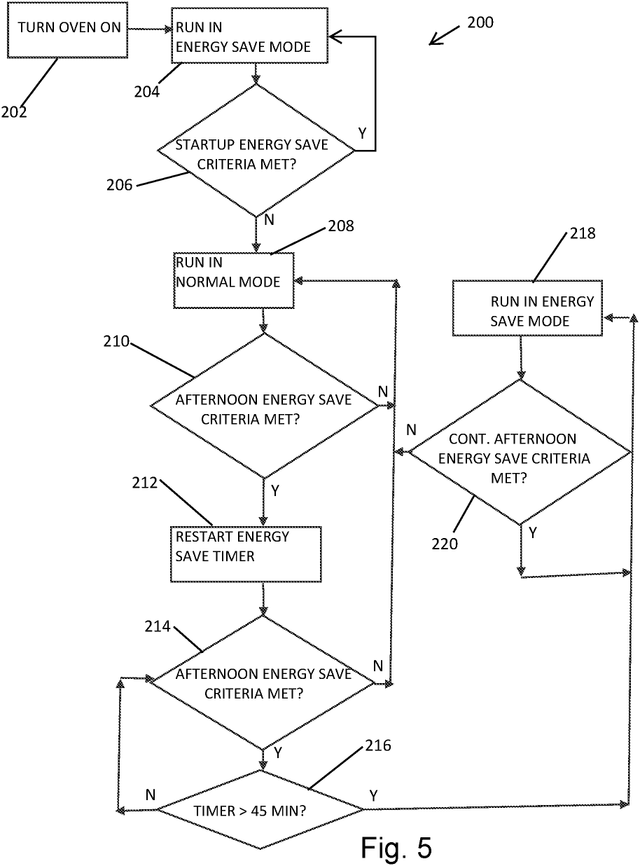

Referring now to FIG. 5, another exemplary variation of oven control, as implemented by the controller 50, is depicted in flow chart 200, which assumes the fan system is set by the user/operator to the fan system high speed. In this variation, the controller is configured for selectively overriding the fan system high speed, such that when the convection cooking oven is initially turned on (e.g., via the on/off switch 38) per step 202, the convection cooking oven is initially operated in an energy save mode, per step 204. In this energy save mode, the fan system is operated at the fan system low speed instead of the fan system high speed, and a temperature within cooking cavity is controlled to an energy save temperature setpoint that is actually lower than the cook temperature setpoint. By way of example, if cook temperature setpoint established by the position of the temperature control knob is 350° F., then the temperature in the cooking cavity may be controlled to an energy save temperature setpoint that is 325° F. or 330° F. or 335° F. or 340° F. or 345° F. (e.g., the energy save temperature setpoint is automatically defined to a setpoint between five and twenty-five degrees Fahrenheit below the cook temperature setpoint, such as a setpoint between ten and fifteen degrees Fahrenheit below the cook temperature setpoint, or at least five degrees Fahrenheit below the cook temperature set point). In other examples, an energy saving benefit, albeit less, can be obtained if the energy save temperature setpoint is two degrees Fahrenheit or more below the cook temperature setpoint.

For reference, controlling the temperature of the cooking cavity to a particular setpoint will typically involve using a range about the particular setpoint to determine when to deliver turn on the heating elements 18 to add heat and when to turn off the heating elements 18 (e.g., if the cooking cavity temperature is being controlled to a setpoint of 340° F., the heater may turn on when the actual sensed temperature within the cavity (e.g., per temperature sensor/thermostat 42) drops below 330° F., and the heating elements may be turned back off when the actual sensed temperature within the cavity rises to 350° F.).

Referring again to the flow chart, per step 206, the oven continues to be operated in the energy save mode for so long as certain startup energy save criteria (e.g., the door remains closed, and cook temperature setpoint remains unchanged) are met. However, once any one of those criteria are no longer met, the oven is automatically switched to operation in a normal mode, per step 208, in which the fan system is operated at the fan system high speed and the temperature in the cooking cavity is controlled to the cook temperature setting. In some examples, the startup energy save criteria may also include that the cooking duration timer is not running. The negatives of these startup energy save criteria (opening of the door, adjustment of the cook temperature setpoint, running of the cook duration timer) act as mode change trigger conditions. These mode change trigger conditions indicated a high likelihood that a food item is being cooked in the oven or is about to be cooked in the oven.

Once the oven is operating in the normal mode, it will continue to operate in the normal mode until for so long as defined energy save condition criteria are not met, per step 210. Moreover, per steps 212, 214 and 216, the defined energy save condition criteria must met for a set time period before operation of the oven is switched to the normal mode. Here, the set time period is forty-five minutes, but variations (e.g., thirty minutes or more, such as between thirty and ninety minutes) are possible. In one implementation, each of the following conditions must be met for the set time period: (i) the door remaining closed (because opening of the door is suggestive an item being placed in the cooking cavity), (ii) an actual temperature within the cooking cavity being no more than a set amount (e.g., 15° F.) below the cook temperature setpoint (because a low temperature is suggestive of an item being placed in the cooking cavity); and (iii) the cook temperature setpoint remaining unchanged (because a user change of the cook temperature setting is suggestive of an item being placed, or about to be placed, in the cooking cavity). Once the conditions are met for the set time period, the oven is automatically switched to operation in the energy save mode again, per step 218, but as soon as any of the conditions are no longer met, per the NO path from step 220, operation of the oven is automatically switched back to the normal operating mode.

Still other variations are possible.

1. A convection cooking oven, comprising:
a cooking cavity for receiving food product to be cooked;
a door movable between an open condition and a closed condition relative to the cooking cavity;
a heater for heating air;
a fan system for moving heated air within the cooking cavity;
a user interface including an on/off switch, a temperature control input for defining a cook temperature setpoint and a fan control input, wherein the fan control input is a fan switch manually variable between a first position corresponding to a fan system high speed and a second position corresponding to a fan system low speed; and
a controller for selectively overriding the fan system high speed, the controller configured such that, with the fan switch in the first position:
when the convection cooking oven is initially turned on via the on/off switch, the convection cooking oven is initially operated in an energy save mode that includes operation of the fan system at the fan system low speed and the convection cooking oven is automatically switched to operation in a normal mode that includes operation of the fan system at the fan system high speed if at least one of a plurality of mode change trigger conditions is detected, the plurality of mode change trigger conditions including:
(i) opening of the door;
(ii) adjustment of the cook temperature setpoint via the temperature control input.

2. The convection cooking oven of claim 1, further comprising a cooking duration timer that is manually triggerable via a timer control input of the user interface, wherein the plurality of mode change trigger conditions further include running of the cooking duration timer.

3. The convection cooking oven of claim 1, wherein the controller is configured such that, in the energy save mode, a temperature within cooking cavity is controlled to an energy save temperature setpoint that is lower than the cook temperature setpoint.

4. The convection cooking oven of claim 3, wherein the controller is configured such that the energy save temperature setpoint is automatically defined to be between five degrees and twenty-five degrees below the cook temperature setpoint.

5. The convection cooking oven of claim 3, wherein the controller is configured such that, when the oven is automatically switched to the normal mode, the temperature within the cooking cavity is controlled to the cook temperature setpoint.

6. The convection cooking oven of claim 1, wherein the controller is configured such that, when the convection cooking oven is operating in the normal mode, the convection cooking oven is automatically switched to operation in the energy save mode after defined energy save condition criteria are met.

7. The convection cooking oven of claim 6, wherein the defined energy save condition criteria are at least each of the following conditions being met for a set time period:
(i) the door remaining closed;
(ii) an actual temperature within the cooking cavity being no more than a set amount below the cook temperature setpoint; and
(iii) the cook temperature setpoint remaining unchanged.

8. The convection cooking oven of claim 7, wherein the set time period is at least thirty minutes.

9. The convection cooking oven of claim 6, wherein the controller is configured such that, in the energy save mode, a temperature within cooking cavity is controlled to an energy save temperature setpoint that is lower than the cook temperature setpoint.

10. The convection cooking oven of claim 9, wherein the controller is configured such that the energy save temperature setpoint is automatically defined to between five degrees and twenty-five degrees below the cook temperature setpoint.

11. A convection cooking oven, comprising:
a cooking cavity for receiving food product to be cooked;
a door movable between an open condition and a closed condition relative to the cooking cavity;
a heater for heating air;
a fan system for moving heated air within the cooking cavity;
a user interface including a temperature control input for defining a cook temperature setpoint and a fan control input for selecting a fan system high speed and at least one fan system low speed; and
a controller for selectively overriding the fan system high speed, the controller configured such that, when the fan control input has been used to select the fan system high speed:
when the convection cooking oven is initially turned on, the convection cooking oven is initially operated in an energy save mode that includes operation of the fan system at a fan system speed that is lower than the fan system high speed.

12. The convection cooking oven of claim 11, wherein the controller is further configured such that the convection cooking oven is automatically switched to operation in a normal mode that includes operation of the fan system at the fan system high speed if at least one of a plurality of mode change trigger conditions is detected, the plurality of mode change trigger conditions including:
(i) opening of the door;
(ii) adjustment of the cook temperature setpoint via the temperature control input.

13. The convection cooking oven of claim 12, further comprising a cooking duration timer that is manually triggerable via a timer control input of the user interface, wherein the plurality of mode change trigger conditions further include running of the cooking duration timer.

14. The convection cooking oven of claim 11, wherein the controller is configured such that, in the energy save mode, a temperature within cooking cavity is controlled to an energy save temperature setpoint that is lower than the cook temperature setpoint.

15. The convection cooking oven of claim 14, wherein the controller is configured such that the energy save temperature setpoint is automatically defined to be between five degrees and twenty-five degrees below the cook temperature setpoint.

16. The convection cooking oven of claim 15, wherein the controller is further configured such that the convection cooking oven is automatically switched to operation in a normal mode that includes operation of the fan system at the fan system high speed and control of the temperature in the cooking cavity to the cook temperature setpoint if at least one of a plurality of change trigger conditions is detected, the plurality of change trigger conditions including:
(i) opening of the door;
(ii) adjustment of a temperature setting via the temperature control input.

17. The convection cooking oven of claim 16, wherein the controller is configured such that, when the convection cooking oven is operating in the normal mode, the convection cooking oven is automatically switched to operation in the energy save mode after defined energy save condition criteria are met.

18. The convection cooking oven of claim 17, wherein the defined energy save condition criteria are at least each of the following conditions being met for a set time period:
(i) the door remaining closed;
(ii) an actual temperature within the cooking cavity being no more than a set amount below the cook temperature setpoint; and
(iii) the cook temperature setpoint remaining unchanged.

19. The convection cooking oven of claim 18, wherein the set time period is at least thirty minutes.

20. A method of operating a convection cooking oven that includes a cooking cavity for receiving food product to be cooked, a door movable between an open condition and a closed condition relative to the cooking cavity, a heater for heating air and a fan system for moving heated air within the cooking cavity, the method comprising:
upon initial oven start-up, automatically:
operating the fan system at a fan system speed that is lower than an actual fan speed setting;
controlling a cooking temperature within the cooking cavity to a temperature that is lower than an actual cook temperature setting;
after at least one trigger condition occurs, automatically:
changing the fan system speed to a speed corresponding to the actual fan speed setting; and
controlling the cooking temperature within the cooking cavity to a temperature that corresponds to the actual cook temperature setting.
